(19) United States
(12) Patent Application Publication
(10) Pub. No.: US 2026/0153486 A1
(43) Pub. Date: Jun. 4, 2026

(54) METHOD FOR SIMULTANEOUS DETERMINATION OF CHLOROGENIC ACID, FERULIC ACID, DRACOHODIN, CINNAMALDEHYDE, LIGUSTILIDE, AND OSTHOLE IN XIANGDU HUOXUE PLASTER

(71) Applicants: Sichuan Second Hospital of T.C.M, Chengdu (CN); Sichuan Academy Of Chinese Medicine Sciences, Chengdu (CN)

(72) Inventors: Wentao SHU, Chengdu (CN); Aijun ZHANG, Chengdu (CN); Shuai LI, Chengdu (CN); Hongmei ZHU, Chengdu (CN); Jiahang WU, Chengdu (CN); Donghui CHEN, Chengdu (CN); Xuchao ZHANG, Chengdu (CN)

(21) Appl. No.: 19/398,269

(22) Filed: Nov. 24, 2025

(30) Foreign Application Priority Data
Nov. 29, 2024 (CN) 202411734615.7

(51) Int. Cl. G01N 30/86; G01N 30/02; G01N 30/04; G01N 30/06; G01N 30/74; G01N 30/88

(52) U.S. Cl. CPC G01N 30/8631; G01N 30/06; G01N 30/74; G01N 2030/027; G01N 2030/047; G01N 2030/062; G01N 2030/884

(57) ABSTRACT

A method for simultaneous determination of chlorogenic acid, ferulic acid, dracohodin, cinnamaldehyde, ligustilide, and osthole in Xiangdu Huoxue Plaster is provided, belonging to the technical field of analytical detection. The method adopts a “quantitative analysis of multi-components by single-marker” (QAMS) approach. Active ingredients from the monarch drugs (Radix Angelicae Pubescentis and Rhizoma Chuanxiong), as well as the minister drugs (Resina Draconis and Cortex Cinnamomi) in the Xiangdu Huoxue Plaster are used as indicators, and cinnamaldehyde (which exhibits a clear pharmacological effect and relatively high content) is selected as an internal standard. Contents of the chlorogenic acid, the ferulic acid, the dracohodin, the cinnamaldehyde, the ligustilide, and the osthole in the Xiangdu Huoxue Plaster are calculated via relative correction factors between the other five compounds to be determined and the cinnamaldehyde.

### CROSS REFERENCE TO RELATED APPLICATION

This patent application claims the benefit and priority of Chinese Patent Application No. 202411734615.7, filed with the China National Intellectual Property Administration on Nov. 29, 2024, the disclosure of which is incorporated by reference herein in its entirety as part of the present application.

### TECHNICAL FIELD

The present disclosure provides a method for simultaneous determination of chlorogenic acid, ferulic acid, dracohodin, cinnamaldehyde, ligustilide, and osthole in Xiangdu Huoxue Plaster, belonging to the technical field of analytical detection.

### BACKGROUND

Xiangdu Huoxue Plaster (a gel plaster) originates from a traditional external-use empirical formula passed down through the family of the renowned orthopedics expert of Traditional Chinese Medicine (TCM), Mr. Du Qiongshu. The plaster is composed of Radix Angelicae Pubescentis, Rhizoma Chuanxiong, Frankincense, Myrrh, Cortex Cinnamomi, Radix Vladimiriae, Fructus Foeniculi, Radix Aconiti Preparata, Radix Aconiti Kusnezoffii Preparata, Resina Draconis, and Borneol. In the prescription, Radix Angelicae Pubescentis, with a pungent and bitter flavor and slightly warm property, demonstrates the efficacy of dispelling wind-damp and relieving pain, making it a crucial medicinal for treating Bi syndrome-related pain (a TCM term referring to impeded qi-blood flow) due to wind-dampness. Mingyi Bielu (Supplements to Records of Famous Physicians) states: “It treats various evil winds, and joint pain due to wind from new or chronic causes.” Rhizoma Chuanxiong, with a pungent flavor and warm property, exhibits the efficacy of activating blood, promoting qi flow, dispelling wind, and relieving pain. Ben Cao Hui Yan (Commentaries on the Materia Medica) calls it a “blood-activating and qi-regulating herb.” These two herbs are used together as the monarch drugs. Frankincense, Myrrh, Resina Draconis, and Cortex Cinnamomi serve as the minister drugs. Among them, Frankincense and Myrrh are used in mutual reinforcement, with the efficacy of activating blood and relieving pain, primarily treating traumatic injuries and pain due to blood stasis. Resina Draconis enters the blood aspect to disperse stasis and relieve pain, making it an essential medicinal in traumatology. These three medicinals, combined with Cortex Cinnamomi which warms and unblocks the blood vessels, further enhance the effect of activating blood and dispelling stasis. Radix Vladimiriae and Fructus Foeniculi regulate qi and relieve pain. Radix Aconiti Preparata and Radix Aconiti Kusnezoffii Preparata dispel wind and eliminate dampness, as well as disperse cold and relieve pain. Changsha Yaojie (Interpretation of Medicinals in the Changsha Prescriptions) states: “Wutou (Aconite), which is warm, drying, and descending, shows a rapid nature of catharsis, opening the joints and closing interstices, and is extremely swift in expelling cold-dampness.” The above four medicinals collectively serve as the assistant drugs. Borneol, with a pungent and bitter flavor and slightly cold property, shows a penetrating nature that can passage through the twelve meridians, and acts as the envoy drug. The combined application of all these medicinals targets blood stasis, qi stagnation, and concurrent invasion of evil wind, cold, and dampness, exerting the effects of activating blood and resolving stasis, dispelling wind and eliminating dampness, and warming the channels to relieve pain. Numerous studies have shown that external treatment methods in TCM hold significant advantages in treating soft tissue injuries. Transdermal drug absorption through the epidermal route can effectively avoid the first-pass effect. Furthermore, the methods are convenient to use and have a definite therapeutic effect, making them highly favored by the public. Consequently, Xiangdu Huoxue Plaster exhibits broad application prospects.

In the prior art, the detection methods for plasters treating soft tissue injuries primarily adopt an external standard method. For example, the prior art has disclosed a method for determining the contents of osthole and ligustilide in Bitong Plaster by high-performance liquid chromatography (HPLC), using an acetonitrile-water mobile phase and a Shiseido C₁₈ MG chromatographic column. However, the aforementioned method only determines the content of active ingredients from one monarch drug “Radix Angelicae Pubescentis” in the Bitong Plaster, and cannot achieve the simultaneous detection of multiple components within the plaster.

### SUMMARY

An objective of the present disclosure is to provide a method for simultaneous determination of chlorogenic acid, ferulic acid, dracohodin, cinnamaldehyde, ligustilide, and osthole in Xiangdu Huoxue Plaster. The method achieves the simultaneous determination of contents of the chlorogenic acid, the ferulic acid, the dracohodin, the cinnamaldehyde, the ligustilide, and the osthole in the Xiangdu Huoxue Plaster, thereby enabling objective, comprehensive, and accurate quality control of the Xiangdu Huoxue Plaster.

To achieve the above objective, the present disclosure provides the following technical solutions:

The present disclosure provides a method for simultaneous determination of chlorogenic acid, ferulic acid, dracohodin, cinnamaldehyde, ligustilide, and osthole in Xiangdu Huoxue Plaster, including the following steps:
dissolving a first cinnamaldehyde reference standard in methanol to obtain a cinnamaldehyde reference standard solution;
subjecting the cinnamaldehyde reference standard solution to first high-performance liquid chromatography (HPLC) detection, thereby obtaining a first cinnamaldehyde reference standard peak area;
removing a protective film from a test sample of the Xiangdu Huoxue Plaster, crushing the test sample, and subjecting an obtained crushed test sample to extraction with a first phosphoric acid-methanol solution to obtain a test sample solution; where the first phosphoric acid-methanol solution includes phosphoric acid at a mass percentage of 2% to 4%;
subjecting the test sample solution to second HPLC detection, thereby obtaining a test sample peak area, and calculating a concentration of the cinnamaldehyde in the test sample solution by an external standard method based on a concentration of the cinnamaldehyde reference standard solution, the first cinnamaldehyde reference standard peak area, and the test sample peak area; and
calculating concentrations of the chlorogenic acid, the ferulic acid, the dracohodin, the ligustilide, and the osthole in the test sample solution based on the first cinnamaldehyde reference standard peak area, the test sample peak area, the concentration of the cinnamaldehyde in the test sample solution, and relative correction factors; where the relative correction factors include a chlorogenic acid correction factor, a ferulic acid correction factor, a dracohodin correction factor, an osthole correction factor, and a ligustilide correction factor;
the first HPLC detection and the second HPLC detection independently include the following conditions: a chromatographic column is a C₁₈ chromatographic column; a mobile phase system includes a mobile phase A and a mobile phase B, where the mobile phase A is an aqueous phosphoric acid solution, the mobile phase B is acetonitrile, and the aqueous phosphoric acid solution includes phosphoric acid at a mass percentage of 0.1% to 0.4%; an elution mode is gradient elution, where a program of the gradient elution includes: 0 min, a volume fraction of the mobile phase A is 95%; 0 min to 5 min, the volume fraction of the mobile phase A is decreased from 95% to 90%; 5 min to 15 min, the volume fraction of the mobile phase A is 90%; 15 min to 17 min, the volume fraction of the mobile phase A is decreased from 90% to 82%; 17 min to 30 min, the volume fraction of the mobile phase A is 82%; 30 min to 31 min, the volume fraction of the mobile phase A is decreased from 82% to 75%; 31 min to 41 min, the volume fraction of the mobile phase A is decreased from 75% to 70%; 41 min to 45 min, the volume fraction of the mobile phase A is 70%; 45 min to 50 min, the volume fraction of the mobile phase A is decreased from 70% to 65%; 50 min to 55 min, the volume fraction of the mobile phase A is decreased from 65% to 52%; 55 min to 85 min, the volume fraction of the mobile phase A is 52%; 85 min to 86 min, the volume fraction of the mobile phase A is decreased from 52% to 0%; 86 min to 90 min, the volume fraction of the mobile phase A is 0%; 90 min to 91 min, the volume fraction of the mobile phase A is increased from 0% to 95%; 91 min to 95 min, the volume fraction of the mobile phase A is 95%; and
the Xiangdu Huoxue Plaster includes a backing material, a protective film, a Chinese herbal composition, and a matrix; where the matrix includes the following components in parts by mass: 10 parts to 45 parts of a framework material, 1 part to 3 parts of a cross-linking agent, 30 parts to 70 parts of a humectant, 1 part to 3 parts of a pH adjuster, 15 parts to 35 parts of a tackifier, and 50 parts to 120 parts of purified water; the Chinese herbal composition includes the following components in parts by mass: 5 parts to 24 parts of Radix Angelicae Pubescentis, 5 parts to 24 parts of Rhizoma Chuanxiong, 5 parts to 24 parts of Radix Vladimiriae, 4 parts to 14 parts of Fructus Foeniculi, 4 parts to 14 parts of Cortex Cinnamomi, 4 parts to 14 parts of Frankincense, 4 parts to 14 parts of Myrrh, 1 part to 12 parts of Radix Aconiti Preparata, 1 part to 12 parts of Radix Aconiti Kusnezoffii Preparata, 1 part to 12 parts of Resina Draconis, and 1 part to 8 parts of Borneol.

Preferably, a process for obtaining the relative correction factors includes the following steps:
dissolving a chlorogenic acid reference standard, a ferulic acid reference standard, a dracohodin reference standard, an osthole reference standard, a ligustilide reference standard, and a second cinnamaldehyde reference standard in a second phosphoric acid-methanol solution to obtain a mixed reference standard solution;
subjecting the mixed reference standard solution to third HPLC detection, thereby obtaining a mixed reference standard peak area; and
using the cinnamaldehyde as an internal standard, and calculating the relative correction factors by the internal standard method based on the mixed reference standard peak area and a concentration of the mixed reference standard solution; where
the mixed reference standard peak area includes a chlorogenic acid reference standard peak area, a ferulic acid reference standard peak area, a dracohodin reference standard peak area, an osthole reference standard peak area, a ligustilide reference standard peak area, and a second cinnamaldehyde reference standard peak area; and
the third HPLC detection includes the following conditions: a chromatographic column is a C₁₈ chromatographic column; a mobile phase system includes a mobile phase A and a mobile phase B, where the mobile phase A is an aqueous phosphoric acid solution, the mobile phase B is acetonitrile, and the aqueous phosphoric acid solution includes phosphoric acid at a mass percentage of 0.1% to 0.4%; an elution mode is gradient elution, where a program of the gradient elution includes: 0 min, a volume fraction of the mobile phase A is 95%; 0 min to 5 min, the volume fraction of the mobile phase A is decreased from 95% to 90%; 5 min to 15 min, the volume fraction of the mobile phase A is 90%; 15 min to 17 min, the volume fraction of the mobile phase A is decreased from 90% to 82%; 17 min to 30 min, the volume fraction of the mobile phase A is 82%; 30 min to 31 min, the volume fraction of the mobile phase A is decreased from 82% to 75%; 31 min to 41 min, the volume fraction of the mobile phase A is decreased from 75% to 70%; 41 min to 45 min, the volume fraction of the mobile phase A is 70%; 45 min to 50 min, the volume fraction of the mobile phase A is decreased from 70% to 65%; 50 min to 55 min, the volume fraction of the mobile phase A is decreased from 65% to 52%; 55 min to 85 min, the volume fraction of the mobile phase A is 52%; 85 min to 86 min, the volume fraction of the mobile phase A is decreased from 52% to 0%; 86 min to 90 min, the volume fraction of the mobile phase A is 0%; 90 min to 91 min, the volume fraction of the mobile phase A is increased from 0% to 95%; 91 min to 95 min, the volume fraction of the mobile phase A is 95%.

Preferably, in the mixed reference standard solution, the second cinnamaldehyde reference standard is at a concentration of 80 μg/mL to 1,890 μg/mL; the chlorogenic acid reference standard is at a concentration of 38 μg/mL to 349 μg/mL; the ferulic acid reference standard is at a concentration of 81 μg/mL to 734 μg/mL; the dracohodin reference standard is at a concentration of 36 μg/mL to 324 μg/mL; the ligustilide reference standard is at a concentration of 90 μg/mL to 1,524 μg/mL; and the osthole reference standard is at a concentration of 28 μg/mL to 252 μg/mL.

Preferably, the third HPLC detection further includes the following conditions: a column temperature is 25° C. to 35° C.; a flow rate of the mobile phase is 0.8 mL/min to 1.2 mL/min; an injection volume is 4 μL to 12 μL; and a detection wavelength is 319 nm to 324 nm.

Preferably, each of the relative correction factors is calculated by a formula: f_{i/r}=AᵢCᵣ/AᵣCᵢ;
f_{i/r} is the relative correction factor; Aᵢ is the second cinnamaldehyde reference standard peak area; Cᵢ is the concentration of the second cinnamaldehyde reference standard in the mixed reference standard solution; Aᵣ is a peak area of a reference standard to be corrected; and Cᵣ is a concentration of the reference standard to be corrected in the mixed reference standard solution; and
the reference standard to be corrected includes the chlorogenic acid reference standard, the ferulic acid reference standard, the dracohodin reference standard, the osthole reference standard, and the ligustilide reference standard.

Preferably, the first cinnamaldehyde reference standard in the cinnamaldehyde reference standard solution is at a concentration of 80 μg/mL to 1,890 μg/mL.

Preferably, the first HPLC detection and the second HPLC detection independently further include the following conditions: a column temperature is 25° C. to 35° C.; a flow rate of the mobile phase is 0.8 mL/min to 1.2 mL/min; an injection volume is 4 μL to 12 μL; and a detection wavelength is 319 nm to 324 nm.

Preferably, the test sample of the Xiangdu Huoxue Plaster and the first phosphoric acid-methanol solution are at a solid-to-liquid ratio of 1 g:(3.56-5) mL.

Preferably, the extraction includes ultrasonic extraction; and the extraction is conducted at 20° C. to 60° C. for 20 min to 40 min.

Preferably, the concentrations of the chlorogenic acid, the ferulic acid, the dracohodin, the ligustilide, and the osthole in the test sample solution are calculated by a formula: Cₓ=AₓCᵢᵢf_{i/r}/Aᵢᵢ;
Cₓ is the concentration of the chlorogenic acid, the ferulic acid, the dracohodin, the osthole, or the ligustilide in the test sample solution; Aₓ is the test sample peak area for the chlorogenic acid, the ferulic acid, the dracoside, the osthole, or the ligustilide; Cᵢᵢ is the concentration of the first cinnamaldehyde reference standard in the cinnamaldehyde reference standard solution; Aᵢᵢ is the first cinnamaldehyde reference standard peak area; and f_{i/r} is the relative correction factor.

The present disclosure provides a method for simultaneous determination of chlorogenic acid, ferulic acid, dracohodin, cinnamaldehyde, ligustilide, and osthole in Xiangdu Huoxue Plaster, including the following steps: dissolving a first cinnamaldehyde reference standard in methanol to obtain a cinnamaldehyde reference standard solution; subjecting the cinnamaldehyde reference standard solution to first HPLC detection, thereby obtaining a first cinnamaldehyde reference standard peak area; removing a protective film from a test sample of the Xiangdu Huoxue Plaster, crushing the test sample, and subjecting an obtained crushed test sample to extraction with a first phosphoric acid-methanol solution to obtain a test sample solution; subjecting the test sample solution to second HPLC detection, thereby obtaining a test sample peak area, and calculating a concentration of the cinnamaldehyde in the test sample solution by an external standard method based on a concentration of the cinnamaldehyde reference standard solution, the first cinnamaldehyde reference standard peak area, and the test sample peak area; and calculating concentrations of the chlorogenic acid, the ferulic acid, the dracohodin, the ligustilide, and the osthole in the test sample solution based on the first cinnamaldehyde reference standard peak area, the test sample peak area, the concentration of the cinnamaldehyde in the test sample solution, and relative correction factors. The method adopts the “quantitative analysis of multi-components by single-marker” (QAMS) approach. Active ingredients from the monarch drugs (Radix Angelicae Pubescentis and Rhizoma Chuanxiong), as well as the minister drugs (Resina Draconis and Cortex Cinnamomi) in the Xiangdu Huoxue Plaster are used as indicators, and cinnamaldehyde (which exhibits a clear pharmacological effect and relatively high content) is selected as an internal standard. Contents of the chlorogenic acid, the ferulic acid, the dracohodin, the cinnamaldehyde, the ligustilide, and the osthole in the Xiangdu Huoxue Plaster are calculated via relative correction factors between the other five compounds to be determined (the chlorogenic acid, the ferulic acid, the dracohodin, the ligustilide, and the osthole) and the cinnamaldehyde. The method achieves the simultaneous determination of the contents of the chlorogenic acid, the ferulic acid, the dracohodin, the cinnamaldehyde, the ligustilide, and the osthole in the Xiangdu Huoxue Plaster, thereby enabling objective, comprehensive, and accurate quality control of the Xiangdu Huoxue Plaster. Furthermore, the method uses only the cinnamaldehyde reference standard as a single external standard, which is simpler to operate and lower in cost compared to the traditional external standard method. The method accurately calculates the contents of the other five compounds to be determined while reducing the use of reference standards, exhibits excellent reproducibility and stability. Therefore, chromatographic peaks are yielded with favorable shapes, providing strong data support for the establishment of quality standards for the Xiangdu Huoxue Plaster.

Moreover, compared with the external standard method used in the prior art, the QAMS approach is more convenient, efficient, and cost-effective. By specifying the HPLC detection conditions (mobile phase A being an aqueous phosphoric acid solution, with a detection wavelength of 319 nm to 324 nm), the obtained chromatograms exhibit better peak shapes. The use of gradient elution enhances the separation of the compounds to be determined, facilitating their detection.

### BRIEF DESCRIPTION OF THE DRAWINGS

FIG. 1 shows the chromatogram of the test mixed reference standard solution;

FIG. 2 shows the chromatogram of the test sample of the Xiangdu Huoxue Plaster;

FIG. 3 shows the chromatogram of test negative sample solution 1;

FIG. 4 shows the chromatogram of test negative sample solution 2;

FIG. 5 shows the chromatogram of test negative sample solution 3; and

FIG. 6 shows the chromatogram of test negative sample solution 4.

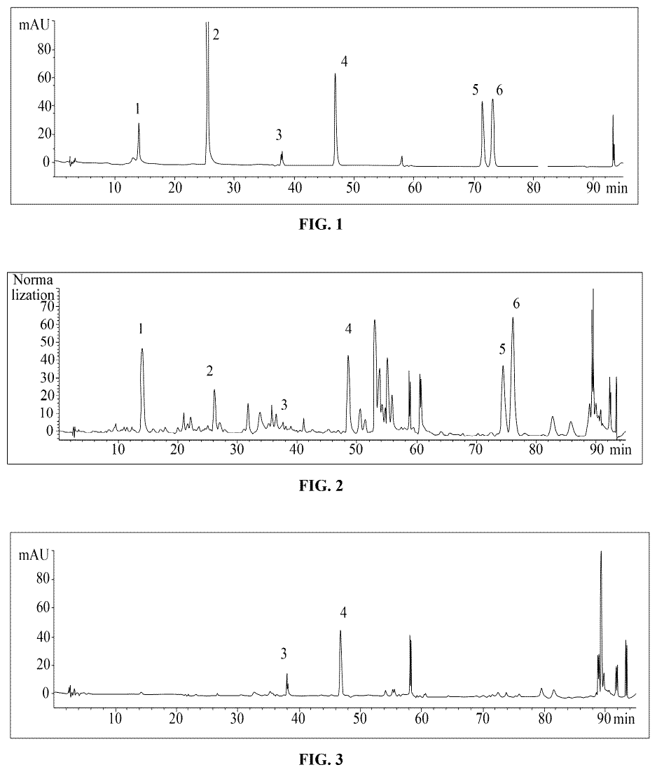

In FIG. 1 to FIG. 6, Peak 1 is chlorogenic acid, Peak 2 is ferulic acid, Peak 3 is dracohodin, Peak 4 is cinnamaldehyde, Peak 5 is osthole, and Peak 6 is ligustilide.

### DETAILED DESCRIPTION OF THE EMBODIMENTS

The present disclosure provides a method for simultaneous determination of chlorogenic acid, ferulic acid, dracohodin, cinnamaldehyde, ligustilide, and osthole in Xiangdu Huoxue Plaster, including the following steps:
dissolving a first cinnamaldehyde reference standard in methanol to obtain a cinnamaldehyde reference standard solution;
subjecting the cinnamaldehyde reference standard solution to first high-performance liquid chromatography (HPLC) detection, thereby obtaining a first cinnamaldehyde reference standard peak area;
removing a protective film from a test sample of the Xiangdu Huoxue Plaster, crushing the test sample, and subjecting an obtained crushed test sample to extraction with a first phosphoric acid-methanol solution to obtain a test sample solution; where the first phosphoric acid-methanol solution includes phosphoric acid at a mass percentage of 2% to 4%;
subjecting the test sample solution to second HPLC detection, thereby obtaining a test sample peak area, and calculating a concentration of the cinnamaldehyde in the test sample solution by an external standard method based on a concentration of the cinnamaldehyde reference standard solution, the first cinnamaldehyde reference standard peak area, and the test sample peak area; and
calculating concentrations of the chlorogenic acid, the ferulic acid, the dracohodin, the ligustilide, and the osthole in the test sample solution based on the first cinnamaldehyde reference standard peak area, the test sample peak area, the concentration of the cinnamaldehyde in the test sample solution, and relative correction factors; where the relative correction factors include a chlorogenic acid correction factor, a ferulic acid correction factor, a dracohodin correction factor, an osthole correction factor, and a ligustilide correction factor;
the first HPLC detection and the second HPLC detection independently include the following conditions: a chromatographic column is a C₁₈ chromatographic column; a mobile phase system includes a mobile phase A and a mobile phase B, where the mobile phase A is an aqueous phosphoric acid solution, the mobile phase B is acetonitrile, and the aqueous phosphoric acid solution includes phosphoric acid at a mass percentage of 0.1% to 0.4%; an elution mode is gradient elution, where a program of the gradient elution includes: 0 min, a volume fraction of the mobile phase A is 95%; 0 min to 5 min, the volume fraction of the mobile phase A is decreased from 95% to 90%; 5 min to 15 min, the volume fraction of the mobile phase A is 90%; 15 min to 17 min, the volume fraction of the mobile phase A is decreased from 90% to 82%; 17 min to 30 min, the volume fraction of the mobile phase A is 82%; 30 min to 31 min, the volume fraction of the mobile phase A is decreased from 82% to 75%; 31 min to 41 min, the volume fraction of the mobile phase A is decreased from 75% to 70%; 41 min to 45 min, the volume fraction of the mobile phase A is 70%; 45 min to 50 min, the volume fraction of the mobile phase A is decreased from 70% to 65%; 50 min to 55 min, the volume fraction of the mobile phase A is decreased from 65% to 52%; 55 min to 85 min, the volume fraction of the mobile phase A is 52%; 85 min to 86 min, the volume fraction of the mobile phase A is decreased from 52% to 0%; 86 min to 90 min, the volume fraction of the mobile phase A is 0%; 90 min to 91 min, the volume fraction of the mobile phase A is increased from 0% to 95%; 91 min to 95 min, the volume fraction of the mobile phase A is 95%; and
the Xiangdu Huoxue Plaster includes a backing material, a protective film, a Chinese herbal composition, and a matrix; where the matrix includes the following components in parts by mass: 10 parts to 45 parts of a framework material, 1 part to 3 parts of a cross-linking agent, 30 parts to 70 parts of a humectant, 1 part to 3 parts of a pH adjuster, 15 parts to 35 parts of a tackifier, and 50 parts to 120 parts of purified water; the Chinese herbal composition includes the following components in parts by mass: 5 parts to 24 parts of Radix Angelicae Pubescentis, 5 parts to 24 parts of Rhizoma Chuanxiong, 5 parts to 24 parts of Radix Vladimiriae, 4 parts to 14 parts of Fructus Foeniculi, 4 parts to 14 parts of Cortex Cinnamomi, 4 parts to 14 parts of Frankincense, 4 parts to 14 parts of Myrrh, 1 part to 12 parts of Radix Aconiti Preparata, 1 part to 12 parts of Radix Aconiti Kusnezoffii Preparata, 1 part to 12 parts of Resina Draconis, and 1 part to 8 parts of Borneol.

In the present disclosure, unless otherwise specified, the reagents added are all commercially available products well known to those skilled in the art.

In the present disclosure, a first cinnamaldehyde reference standard is dissolved in methanol to obtain a cinnamaldehyde reference standard solution. The concentration of the first cinnamaldehyde reference standard in the cinnamaldehyde reference standard solution is preferably 80-1,890 μg/mL, more preferably 400-1,240 μg/mL, and most preferably 700-890 μg/mL. A preparation process of the cinnamaldehyde reference standard solution preferably includes the following steps: dissolving the first cinnamaldehyde reference standard in methanol to obtain a first cinnamaldehyde reference standard stock solution; diluting the first cinnamaldehyde reference standard stock solution with methanol to obtain the cinnamaldehyde reference standard solution. The concentration of the first cinnamaldehyde reference standard stock solution is preferably 0.4-9.8 mg/mL, more preferably 2-6.4 mg/mL, and most preferably 3.5-5.4 mg/mL.

In the present disclosure, the cinnamaldehyde reference standard solution is subjected to first HPLC detection, thereby obtaining a first cinnamaldehyde reference standard peak area.

In the present disclosure, the conditions for the first HPLC detection include: the chromatographic column is a C₁₈ chromatographic column, and the C₁₈ chromatographic column preferably includes an Agilent Eclipse CDB-C₁₈ chromatographic column, an Agilent ZORBAX Eclipse XDB-C₁₈ chromatographic column, a Diamonsil C₁₈ chromatographic column, or a Welchrom C₁₈ chromatographic column; the C₁₈ chromatographic column has a specification of preferably 4.6 mm×250 mm, 5 μm; the mobile phase system includes a mobile phase A and a mobile phase B, where the mobile phase A is an aqueous phosphoric acid solution, the mass percentage of phosphoric acid in the aqueous phosphoric acid solution is 0.1% to 0.4%, preferably 0.2% to 0.4%, more preferably 0.3% to 0.4%; the mobile phase B is acetonitrile; an elution mode is gradient elution, and a program of the gradient elution is as follows: 0 min, the volume fraction of mobile phase A is 95%; 0-5 min, the volume fraction of mobile phase A is decreased from 95% to 90%; 5-15 min, the volume fraction of mobile phase A is 90%; 15-17 min, the volume fraction of mobile phase A is decreased from 90% to 82%; 17-30 min, the volume fraction of mobile phase A is 82%; 30-31 min, the volume fraction of mobile phase A is decreased from 82% to 75%; 31-41 min, the volume fraction of mobile phase A is decreased from 75% to 70%; 41-45 min, the volume fraction of mobile phase A is 70%; 45-50 min, the volume fraction of mobile phase A is decreased from 70% to 65%; 50-55 min, the volume fraction of mobile phase A is decreased from 65% to 52%; 55-85 min, the volume fraction of mobile phase A is 52%; 85-86 min, the volume fraction of mobile phase A is decreased from 52% to 0%; 86-90 min, the volume fraction of mobile phase A is 0%; 90-91 min, the volume fraction of mobile phase A is increased from 0% to 95%; 91-95 min, the volume fraction of mobile phase A is 95%; a column temperature is preferably 25° C. to 35° C., more preferably 28° C. to 32° C., and most preferably 29° C. to 30° C.; a flow rate of the mobile phase is preferably 0.8-1.2 mL/min, more preferably 0.9-1.1 mL/min, and most preferably 1-1.1 mL/min; an injection volume is preferably 4-12 μL, more preferably 6-11 μL, and most preferably 8-10 μL; a detection wavelength is preferably 319-324 nm, more preferably 320-323 nm, and most preferably 321-323 nm.

In the present disclosure, a protective film is removed from a test sample of the Xiangdu Huoxue Plaster, the test sample is crushed, and an obtained crushed test sample is subjected to extraction with a first phosphoric acid-methanol solution to obtain a test sample solution.

In the present disclosure, the Xiangdu Huoxue Plaster includes a backing material, a protective film, a Chinese herbal composition, and a matrix.

In the present disclosure, the backing material is preferably one or more selected from the group consisting of non-woven fabric, cotton cloth, and paper.

In the present disclosure, the protective film is preferably one or more selected from the group consisting of plastic film, release paper, and aluminum foil-polyethylene composite film.

In parts by mass, the matrix includes: 10-45 parts of a framework material, preferably 12-30 parts, specifically preferably 15 parts; where the framework material is preferably a neutralized sodium polyacrylate product, more preferably sodium polyacrylate NP-700; 1-3 parts of a cross-linking agent, preferably 1.1-2 parts, specifically preferably 1.2 parts; where the cross-linking agent is preferably an aluminum compound, more preferably dihydroxyaluminum aminoacetate; 30-70 parts of a humectant, preferably 40-60 parts, specifically preferably 50 parts; where the humectant is preferably one or more selected from the group consisting of glycerol, propylene glycol, and polyethylene glycol, more preferably glycerol; 1-3 parts of a pH adjuster, preferably 1.1-2 parts, specifically preferably 1.3 parts; where the pH adjuster is preferably one selected from the group consisting of tartaric acid, citric acid, lactic acid, and malic acid, more preferably tartaric acid; 15-35 parts of a tackifier, preferably 12-30 parts, specifically preferably 15 parts; where the tackifier is preferably one or more selected from the group consisting of gelatin, arabic gum, Carbomer 940, sodium carboxymethyl cellulose, and hypromellose, more preferably Carbomer 940; 50-120 parts of purified water, preferably 55-100 parts, specifically preferably 60 parts.

In parts by mass, the Chinese herbal composition includes: 5-24 parts of Radix Angelicae Pubescentis, preferably 12-20 parts, specifically preferably 14 parts; 5-24 parts of Rhizoma Chuanxiong, preferably 12-20 parts, specifically preferably 14 parts; 5-24 parts of Radix Vladimiriae, preferably 12-20 parts, specifically preferably 14 parts; 4-14 parts of Fructus Foeniculi, preferably 6-11 parts, specifically preferably 8 parts; 4-14 parts of Cortex Cinnamomi, preferably 6-11 parts, specifically preferably 8 parts; 4-14 parts of Frankincense, preferably 6-11 parts, specifically preferably 8 parts; 4-14 parts of Myrrh, preferably 6-11 parts, specifically preferably 8 parts; 1-12 parts of Radix Aconiti Preparata, preferably 2-11 parts, specifically preferably 6 parts; 1-12 parts of Radix Aconiti Kusnezoffii Preparata, preferably 2-11 parts, specifically preferably 6 parts; 1-12 parts of Resina Draconis, preferably 2-11 parts, specifically preferably 6 parts; 1-8 parts of Borneol, preferably 2-7 parts, specifically preferably 3 parts.

In the present disclosure, the first phosphoric acid-methanol solution includes phosphoric acid at a mass percentage of 2% to 4%, preferably 2.5% to 3.5%, more preferably 2.8% to 3.2%, and most preferably 2.9% to 3%. The solid-to-liquid ratio of the test sample of the Xiangdu Huoxue Plaster to the first phosphoric acid-methanol solution is preferably 1 g: (3.56-5) mL, more preferably 1 g: (3.6-4.3) mL, and most preferably 1 g: (3.7-4) mL. The extraction preferably includes ultrasonic extraction; the extraction is conducted at preferably 20° C. to 60° C., more preferably 30° C. to 50° C., and most preferably 40° C. to 45° C. for preferably 20-40 min, more preferably 25-35 min, and most preferably 28-30 min.

In the present disclosure, the extraction preferably includes the following steps: placing the test sample of the Xiangdu Huoxue Plaster into the first phosphoric acid-methanol solution, weighing an obtained mixture, conducting ultrasonic extraction, weighing an obtained extraction product, replenishing a weight loss with the first phosphoric acid-methanol solution, filtering, and collecting an obtained filtrate as the test sample solution.

In the present disclosure, the test sample solution is subjected to second HPLC detection, thereby obtaining a test sample peak area, and a concentration of the cinnamaldehyde in the test sample solution is calculated by an external standard method based on a concentration of the cinnamaldehyde reference standard solution, the first cinnamaldehyde reference standard peak area, and the test sample peak area.

In the present disclosure, the conditions for the second HPLC detection are the same as those for the first HPLC detection, and are not repeated herein.

In the present disclosure, the concentration of the cinnamaldehyde in the test sample solution is preferably calculated by a formula: C_{y}=AₓC_{w}/A_{w}; where C_{y} is the concentration of the cinnamaldehyde in the test sample solution; Aₓ is the test sample peak area for the chlorogenic acid, the ferulic acid, the dracoside, the osthole, or the ligustilide; C_{w} is the concentration of the cinnamaldehyde reference standard solution; and A_{w} is the first cinnamaldehyde reference standard peak area.

In the present disclosure, after obtaining the first cinnamaldehyde reference standard peak area, the test sample peak area, and the concentration of the cinnamaldehyde in the test sample solution, the concentrations of chlorogenic acid, ferulic acid, dracohodin, ligustilide, and osthole in the test sample solution are calculated based on the first cinnamaldehyde reference standard peak area, the test sample peak area, the concentration of the cinnamaldehyde in the test sample solution, and relative correction factors.

In the present disclosure, the relative correction factors are a chlorogenic acid correction factor, a ferulic acid correction factor, a dracohodin correction factor, an osthole correction factor, and a ligustilide correction factor, respectively. A process for obtaining the relative correction factors preferably includes the following steps: dissolving a chlorogenic acid reference standard, a ferulic acid reference standard, a dracohodin reference standard, an osthole reference standard, a ligustilide reference standard, and a second cinnamaldehyde reference standard in a second phosphoric acid-methanol solution to obtain a mixed reference standard solution; subjecting the mixed reference standard solution to third HPLC detection, thereby obtaining a mixed reference standard peak area; using the cinnamaldehyde as an internal standard, and calculating the relative correction factors by an internal standard method based on the mixed reference standard peak area and a concentration of the mixed reference standard solution. The mixed reference standard peak area preferably includes a chlorogenic acid reference standard peak area, a ferulic acid reference standard peak area, a dracohodin reference standard peak area, an osthole reference standard peak area, a ligustilide reference standard peak area, and a second cinnamaldehyde reference standard peak area.

In the present disclosure, in the mixed reference standard solution, the concentration of the second cinnamaldehyde reference standard is preferably 80-1,890 μg/mL, more preferably 400-890 μg/mL, and most preferably 750-890 μg/mL; the concentration of the chlorogenic acid reference standard is preferably 38-349 μg/mL, more preferably 100-300 μg/mL, and most preferably 194-252 μg/mL; the concentration of the ferulic acid reference standard is preferably 81-734 μg/mL, more preferably 100-600 μg/mL, and most preferably 300-408 μg/mL; the concentration of the dracohodin reference standard is preferably 36-324 μg/mL, more preferably 100-300 μg/mL, and most preferably 180-250 μg/mL; the concentration of the ligustilide reference standard is preferably 90-1,524 μg/mL, more preferably 500-1,500 μg/mL, and most preferably 900-1,200 μg/mL; the concentration of the osthole reference standard is preferably 28-252 μg/mL, more preferably 100-200 μg/mL, and most preferably 143-180 μg/mL.

In the present disclosure, the dissolving the chlorogenic acid reference standard, ferulic acid reference standard, dracohodin reference standard, osthole reference standard, ligustilide reference standard, and the second cinnamaldehyde reference standard in the second phosphoric acid-methanol solution preferably includes the following steps: mixing the chlorogenic acid reference standard with methanol to obtain a chlorogenic acid reference standard stock solution; mixing the ferulic acid reference standard with methanol to obtain a ferulic acid reference standard stock solution; mixing the second cinnamaldehyde reference standard with methanol to obtain a second cinnamaldehyde reference standard stock solution; mixing the osthole reference standard with methanol to obtain an osthole reference standard stock solution; mixing the ligustilide reference standard with methanol to obtain a ligustilide reference standard stock solution; mixing the dracohodin reference standard with a third phosphoric acid-methanol solution to obtain a dracohodin reference standard stock solution; and mixing the chlorogenic acid reference standard stock solution, ferulic acid reference standard stock solution, second cinnamaldehyde reference standard stock solution, osthole reference standard stock solution, ligustilide reference standard stock solution, dracohodin reference standard stock solution, and a fourth phosphoric acid-methanol solution to obtain the mixed reference standard solution.

In the present disclosure, the concentration of the chlorogenic acid reference standard stock solution is preferably 0.194-1.746 mg/mL, more preferably 0.5-1.5 mg/mL, and most preferably 0.97-1 mg/mL; the concentration of the ferulic acid reference standard stock solution is preferably 0.408-3.672 mg/mL, more preferably 1-3 mg/mL, and most preferably 2.04-2.5 mg/mL; the concentration of the second cinnamaldehyde reference standard stock solution is preferably 0.4-5.8 mg/mL, more preferably 2-5.4 mg/mL, and most preferably 3.8-5.4 mg/mL; the concentration of the osthole reference standard stock solution is preferably 0.14-1.26 mg/mL, more preferably 0.5-1 mg/mL, and most preferably 0.7-0.8 mg/mL; the concentration of the ligustilide reference standard stock solution is preferably 0.743-5.287 mg/mL, more preferably 2.15-4.5 mg/mL, and most preferably 3.0-3.9 mg/ml; the concentration of the dracohodin reference standard stock solution is preferably 0.18-1.62 mg/mL, more preferably 0.5-1.5 mg/mL, and most preferably 0.9-1 mg/mL. The concentration of the third phosphoric acid-methanol solution is preferably 2% to 4%, more preferably 2.5% to 3.5%, and most preferably 2.9% to 3%; the concentration of the fourth phosphoric acid-methanol solution is preferably 2% to 4%, more preferably 2.5% to 3.5%, and most preferably 2.9% to 3%.

In the present disclosure, the conditions for the third HPLC detection are the same as those for the first HPLC detection, and are not repeated herein.

In the present disclosure, each of the relative correction factors is preferably calculated by a formula: f_{i/r}=AᵢCᵣ/AᵣCᵢ; where f_{i/r} is the relative correction factor; Aᵢ is the second cinnamaldehyde reference standard peak area; Cᵢ is the concentration of the second cinnamaldehyde reference standard in the mixed reference standard solution; Aᵣ is a peak area of a reference standard to be corrected; and Cᵣ is a concentration of the reference standard to be corrected in the mixed reference standard solution; and the reference standard to be corrected includes preferably the chlorogenic acid reference standard, ferulic acid reference standard, dracohodin reference standard, osthole reference standard, and ligustilide reference standard.

In the present disclosure, the concentrations of chlorogenic acid, ferulic acid, dracohodin, ligustilide, or osthole in the test sample solution are preferably calculated by a formula: Cₓ=AₓCᵢᵢf_{i/r}/Aᵢᵢ; where Cₓ is the concentration of the chlorogenic acid, the ferulic acid, the dracohodin, the osthole, or the ligustilide in the test sample solution; Aₓ is the test sample peak area for the chlorogenic acid, the ferulic acid, the dracoside, the osthole, or the ligustilide; Cᵢᵢ is the concentration of the first cinnamaldehyde reference standard in the cinnamaldehyde reference standard solution; Aᵢᵢ is the first cinnamaldehyde reference standard peak area; and f_{i/r} is the relative correction factor.

In order to further illustrate the present disclosure, the method for simultaneous determination of chlorogenic acid, ferulic acid, dracohodin, cinnamaldehyde, ligustilide, and osthole in Xiangdu Huoxue Plaster provided in the present disclosure is described in detail below in conjunction with the accompanying drawings and examples, which are not to be construed as limiting the scope of protection of the present disclosure.

In all examples of the present disclosure, the instruments used were as follows: the chromatograph was a Shimadzu High-Performance Liquid Chromatograph (Shimadzu, Japan) and an Agilent 1200 High-Performance Liquid Chromatograph; the chromatographic columns were an Agilent Eclipse XDB-C₁₈ column, a Diamonsil C₁₈ column, and a Welchrom C₁₈ column; a YH-C20002 electronic analytical balance (Wuxin Weighing Apparatus); a JY5002 electronic analytical balance (LIANG PING); a KQ-300B ultrasonic cleaner (Kunshan Hechuang Ultrasonic Instrument Co., Ltd.).

The reagents used were: chlorogenic acid (Batch No.: 110753-202119), ferulic acid (Batch No.: 110773-201915), dracohodin (Batch No.: 110811-202108), cinnamaldehyde (Batch No.: 110710-202223), and osthole (Batch No.: 110822-202111) were purchased from the National Institutes for Food and Drug Control, China; ligustilide (Batch No.: RFS-G01001909024) was purchased from Chengdu Herbpurify Co., Ltd.; methanol (analytical grade); ethanol (analytical grade); acetonitrile (HPLC grade); phosphoric acid (HPLC grade); ultrapure water.

The HPLC detection conditions included: the chromatographic column used in Example 1 was an Agilent Eclipse CDB-C₁₈ column; the chromatographic columns used in Example 2 were an Agilent Eclipse XDB-C₁₈ column, a Diamonsil C₁₈ column, and a Welchrom C₁₈ column; the aforementioned chromatographic columns had a specification of 4.6 mm×250 mm, 5 μm; the mobile phase included a mobile phase A and a mobile phase B, where the mobile phase A was an aqueous phosphoric acid solution, the mobile phase B was acetonitrile, and the mass percentage of phosphoric acid in the aqueous phosphoric acid solution was 0.3%; an elution mode was gradient elution, and a program of the gradient elution was as follows: 0 min, the volume fraction of mobile phase A was 95%; 0-5 min, the volume fraction of mobile phase A was decreased from 95% to 90%; 5-15 min, the volume fraction of mobile phase A was 90%; 15-17 min, the volume fraction of mobile phase A was decreased from 90% to 82%; 17-30 min, the volume fraction of mobile phase A was 82%; 30-31 min, the volume fraction of mobile phase A was decreased from 82% to 75%; 31-41 min, the volume fraction of mobile phase A was decreased from 75% to 70%; 41-45 min, the volume fraction of mobile phase A was 70%; 45-50 min, the volume fraction of mobile phase A was decreased from 70% to 65%; 50-55 min, the volume fraction of mobile phase A was decreased from 65% to 52%; 55-85 min, the volume fraction of mobile phase A was 52%; 85-86 min, the volume fraction of mobile phase A was decreased from 52% to 0%; 86-90 min, the volume fraction of mobile phase A was 0%; 90-91 min, the volume fraction of mobile phase A was increased from 0% to 95%; 91-95 min, the volume fraction of mobile phase A was 95%; a flow rate of the mobile phase was 1 mL/min; an injection volume was 10 μL; and a detection wavelength was 321 nm.

The test sample of the Xiangdu Huoxue Plaster included a backing material, a protective film, a Chinese herbal composition, and a matrix. In parts by mass, the matrix included: 15 parts of a framework material (neutralized sodium polyacrylate product); 1.2 parts of a cross-linking agent (aluminum compound); 50 parts of a humectant (polyol compound); 1.3 parts of a pH adjuster (carboxylic acid compound); 15 parts of a tackifier (Carbomer 940); and 60 parts of purified water. In parts by mass, the Chinese herbal composition included: 14 parts of Radix Angelicae Pubescentis; 14 parts of Rhizoma Chuanxiong; 14 parts of Radix Vladimiriae; 8 parts of Fructus Foeniculi; 8 parts of Cortex Cinnamomi; 8 parts of Frankincense; 8 parts of Myrrh; 6 parts of Radix Aconiti Preparata; 6 parts of Radix Aconiti Kusnezoffii Preparata; 6 parts of Resina Draconis; and 3 parts of Borneol.

### Example 1

Chlorogenic acid reference standard, ferulic acid reference standard, cinnamaldehyde reference standard, osthole reference standard, and ligustilide reference standard were taken and dissolved separately in methanol to obtain a chlorogenic acid reference standard stock solution with a concentration of 0.97 mg/mL, a ferulic acid reference standard stock solution with a concentration of 2.04 mg/mL, a cinnamaldehyde reference standard stock solution with a concentration of 4.8 mg/mL, an osthole reference standard stock solution with a concentration of 0.7 mg/mL, and a ligustilide reference standard stock solution with a concentration of 3.9 mg/mL. The dracohodin reference standard was taken and dissolved in a phosphoric acid-methanol solution with a mass concentration of 3% to obtain a dracohodin reference standard stock solution with a concentration of 0.9 mg/mL.

The chlorogenic acid reference standard stock solution, ferulic acid reference standard stock solution, dracohodin reference standard stock solution, cinnamaldehyde reference standard stock solution, osthole reference standard stock solution, and ligustilide reference standard stock solution were taken, dissolved, and made up to volume in a 5 mL volumetric flask using a phosphoric acid-methanol solution with a mass concentration of 3% to obtain a mixed reference standard solution (denoted as Mixed Standard A) containing chlorogenic acid at 194 μg/mL, ferulic acid at 408 μg/mL, dracohodin at 180 μg/mL, cinnamaldehyde at 960 μg/mL, osthole at 140 μg/mL, and ligustilide at 780 μg/mL. Mixed Standard A was sequentially diluted to obtain Mixed Standard B, Mixed Standard C, Mixed Standard D, Mixed Standard E, and Mixed Standard F, where the cinnamaldehyde concentrations were 480 μg/mL, 192 μg/mL, 96 μg/mL, 48 μg/mL, and 9.6 μg/mL, respectively.

A test sample of the Xiangdu Huoxue Plaster was taken, the protective film was removed, and the test sample was cut into pieces. A phosphoric acid-methanol solution with a mass concentration of 3% was added, and the mixture was ultrasonically extracted at 30° C. for 30 min. The mixture was weighed, and the weight loss was replenished with the phosphoric acid-methanol solution (mass concentration of 3%). The mixture was then filtered through a microporous membrane, and the filtrate was obtained as the test sample solution.

Exactly 10 μL each of Mixed Standards A through F was drawn, and 10 μL each of 6 batches of the test solution (denoted sequentially as Test Sample A, Test Sample B, Test Sample C, Test Sample D, Test Sample E, and Test Sample F) was taken. These were separately detected using the HPLC conditions provided in the present disclosure. The chromatogram of the test sample solution is shown in FIG. 1. It can be seen from FIG. 1 that when the test sample solution was detected using the HPLC conditions provided in the present disclosure, the peaks of the 6 target compounds in the test sample solution exhibited good shape and high resolution.

The concentrations of the 6 compounds in Xiangdu Huoxue Plaster were calculated using the method provided in the present disclosure and the external standard method, and the results are shown in Table 1.

TABLE 1
Results of content determination of 6 compounds in Xiangdu Huoxue Plaster (Unit: μg/mL)

| | Chlorogenic acid | | Ferulic acid | | Dracohodin | | Cinnamaldehyde | Osthole | | Ligustilide | |
|---|---|---|---|---|---|---|---|---|---|---|---|
| | External | | External | | External | | External | External | | External | |
| | standard | | standard | | standard | | standard | standard | | standard | |
| SN | method | QAMS | method | QAMS | method | QAMS | method | method | QAMS | method | QAMS |
| Test | 39.5035 | 39.2817 | 10.2300 | 10.2682 | 32.9228 | 33.1919 | 812.7707 | 95.7519 | 96.5573 | 196.7037 | 202.6049 |
| Sample A | | | | | | | | | | | |
| Test | 39.9379 | 39.7137 | 9.7892 | 9.8258 | 27.9406 | 28.1690 | 790.4333 | 91.5008 | 92.2705 | 191.6875 | 197.4381 |
| Sample B | | | | | | | | | | | |
| Test | 41.3022 | 41.0703 | 10.2546 | 10.2929 | 32.1485 | 32.4113 | 821.9456 | 96.2056 | 97.0149 | 200.5809 | 206.5983 |
| Sample C | | | | | | | | | | | |
| Test | 41.2794 | 41.0476 | 10.5517 | 10.5911 | 31.7109 | 31.9701 | 706.6599 | 98.2957 | 99.1225 | 197.7574 | 203.6902 |
| Sample D | | | | | | | | | | | |
| Test | 42.5179 | 42.2792 | 10.6955 | 10.7354 | 28.3109 | 28.5423 | 715.3484 | 95.3917 | 96.1941 | 198.3189 | 204.2684 |
| Sample E | | | | | | | | | | | |
| Test | 40.1094 | 39.8842 | 10.4779 | 10.5170 | 34.6733 | 31.5629 | 773.5748 | 97.0819 | 97.8986 | 198.3352 | 204.2852 |
| Sample F | | | | | | | | | | | |

As shown in Table 1, the results obtained by the detection method provided in the present disclosure showed no significant difference compared to those obtained by the external standard method.

### Example 2

### Methodology Investigation

### 1. Investigation of Linear Relationships

The Mixed Standards A through F prepared in Example 1 were taken and detected sequentially using the HPLC conditions provided in the present disclosure. Using the concentration of the reference standards in the mixed standard solution as the X-axis and the chromatographic peak areas of the reference standards as the Y-axis, standard curves were plotted. The obtained linear regression equations and linear relationships (linear range R² and correlation coefficient) are shown in Table 2.

TABLE 2
Linear regression equations and linear relationships
(linear range R² and correlation coefficient)

| | | | Linear |
|---|---|---|---|
| Component | Regression equation | R² | range/μg · mL⁻¹ |
| Chlorogenic acid | Y = 31.73X − 33.41 | 0.9991 | 1.94-194 |
| Ferulic acid | Y = 60.095X − 72.136 | 0.9995 | 4.08-408 |
| Dracohodin | Y = 23.699X + 51.156 | 0.9997 | 1.80-180 |
| Cinnamaldehyde | Y = 3.4313X + 4.6433 | 0.9993 | 9.60-960 |
| Ligustilide | Y = 24.587X − 8.5782 | 0.9992 | 7.80-780 |
| Osthole | Y = 50.988X + 63.479 | 0.9991 | 1.43-143 |

As shown in Table 2, when tested using the method provided in the present disclosure, chlorogenic acid, ferulic acid, dracohodin, cinnamaldehyde, ligustilide, and osthole all exhibited desirable linearity within their respective ranges.

### 2. Specificity Verification

The other 9 medicinal materials except Radix Angelicae Pubescentis and Rhizoma Chuanxiong (namely Cortex Cinnamomi, Fructus Foeniculi, Radix Vladimiriae, Radix Aconiti Preparata, Radix Aconiti Kusnezoffii Preparata, Vinegar-processed Frankincense, Vinegar-processed Myrrh, Resina Draconis, and Borneol) were powdered into a fine powder. According to the dosage provided in the prescription of the present disclosure, a negative sample (denoted as Sample 1) lacking chlorogenic acid, ferulic acid, ligustilide, and osthole was prepared.

The other 10 medicinal materials except Radix Angelicae Pubescentis (namely Rhizoma Chuanxiong, Cortex Cinnamomi, Fructus Foeniculi, Radix Vladimiriae, Radix Aconiti Preparata, Radix Aconiti Kusnezoffii Preparata, Vinegar-processed Frankincense, Vinegar-processed Myrrh, Resina Draconis, and Borneol) were powdered into a fine powder. According to the dosage provided in the prescription of the present disclosure, a negative sample (denoted as Sample 2) lacking osthole was prepared.

The other 10 medicinal materials except Cortex Cinnamomi (namely Radix Angelicae Pubescentis, Rhizoma Chuanxiong, Fructus Foeniculi, Radix Vladimiriae, Radix Aconiti Preparata, Radix Aconiti Kusnezoffii Preparata, Vinegar-processed Frankincense, Vinegar-processed Myrrh, Resina Draconis, and Borneol) were powdered into a fine powder. According to the dosage provided in the prescription of the present disclosure, a negative sample (denoted as Sample 3) lacking cinnamaldehyde was prepared.

The other 10 medicinal materials except Resina Draconis (namely Radix Angelicae Pubescentis, Rhizoma Chuanxiong, Cortex Cinnamomi, Fructus Foeniculi, Radix Vladimiriae, Radix Aconiti Preparata, Radix Aconiti Kusnezoffii Preparata, Vinegar-processed Frankincense, Vinegar-processed Myrrh, and Borneol) were powdered into a fine powder. According to the dosage provided in the prescription of the present disclosure, a negative sample (denoted as Sample 4) lacking dracohodin was prepared.

The above Samples 1 through 4 were prepared into test negative sample solutions (denoted sequentially as Test Negative Sample Solution 1, Test Negative Sample Solution 2, Test Negative Sample Solution 3, and Test Negative Sample Solution 4) according to the preparation method for the test sample solution provided in the present disclosure, using the mixed reference standard solution as a control.

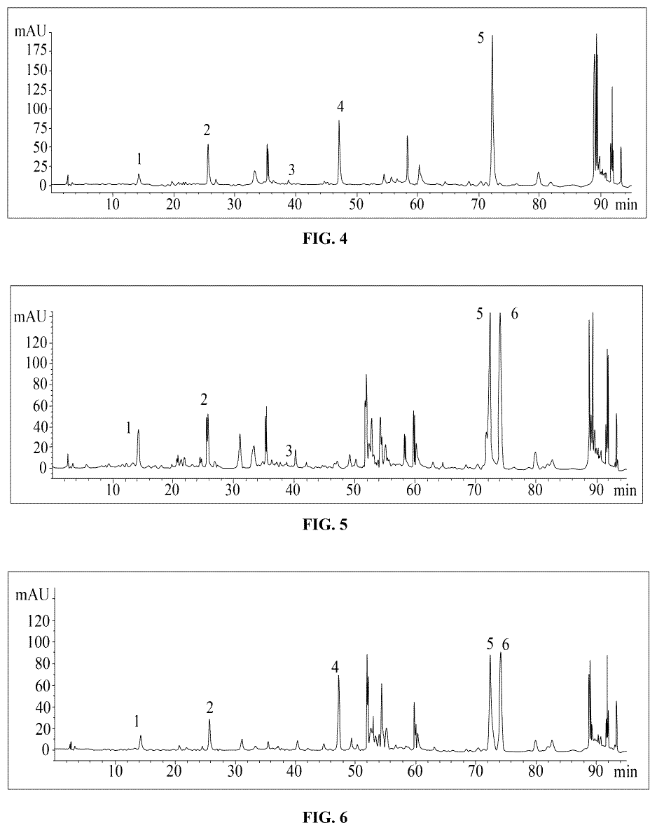

The test negative sample solutions 1 through 4 were subjected to HPLC detection. FIG. 3 shows the chromatogram of Test Negative Sample Solution 1; FIG. 4 shows the chromatogram of Test Negative Sample Solution 2; FIG. 5 shows the chromatogram of Test Negative Sample Solution 3; and

FIG. 6 shows the chromatogram of Test Negative Sample Solution 4. As can be seen from FIG. 3 to FIG. 6, Test Negative Sample Solution 1 showed no chromatographic peaks at the retention times of chlorogenic acid, ferulic acid, ligustilide, and osthole; Test Negative Sample Solution 2 showed no chromatographic peak at the retention time of osthole; Test Negative Sample Solution 3 showed no chromatographic peak at the retention time of cinnamaldehyde; and Test Negative Sample Solution 4 showed no chromatographic peak at the retention time of dracohodin. This proves that the HPLC detection method provided in this application shows desirable specificity.

### 3. Instrument Precision Test

A 10 μL aliquot of Mixed Standard B was taken and injected consecutively 6 times. The relative standard deviation (RSD) of the peak areas for the 6 components was calculated. The RSDs (n=6) of the peak areas for chlorogenic acid, ferulic acid, dracohodin, cinnamaldehyde, ligustilide, and osthole were 0.46%, 0.39%, 0.20%, 0.36%, 0.27%, and 0.94%, respectively, all less than 3%, indicating excellent instrument precision.

### 4. Solution Stability Test

The same test sample solution was taken and analyzed by injection at 0, 2, 4, 8, 12, and 24 h after preparation. The peak areas of each analyte were measured, and the RSDs (n=6) of the peak areas for chlorogenic acid, ferulic acid, dracohodin, cinnamaldehyde, ligustilide, and osthole were calculated to be 0.94%, 0.96%, 0.34%, 1.27%, 0.74%, and 1.37%, respectively, all less than 3%, indicating that the test sample solution was relatively stable within 24 h.

### 5. Repeatability Test

6 portions were taken from the same batch of the test sample of the Xiangdu Huoxue Plaster, and 6 test sample solutions were prepared in parallel. These were detected using the HPLC conditions provided in the present disclosure. The measured RSDs for the contents of chlorogenic acid, ferulic acid, dracohodin, cinnamaldehyde, ligustilide, and osthole were 1.45%, 1.35%, 1.50%, 2.33%, 2.89%, and 1.47%, respectively, all less than 3%, indicating excellent method repeatability.

### 6. Spike Recovery Test

9 portions of test sample E were taken and accurately weighed. Reference standards were added at 3 levels: 80%, 100%, and 120% of the known content (3 sample portions per level). The test sample solutions were prepared using the method provided in the present disclosure, injected for determination, and the spike recovery rates of the 6 target compounds in the test sample of the Xiangdu Huoxue Plaster were calculated. The results are shown in Tables 3 to 8, respectively.

TABLE 3
Results of spike recovery test for chlorogenic
acid in test sample of Xiangdu Huoxue Plaster

| | | | | | | Average | |
|---|---|---|---|---|---|---|---|
| | Sampled | Sample | Added | Measured | Spike | spike | |
| | amount/ | content/ | amount/ | amount/ | recovery | recovery | RSD/ |
| Component | g | mg | mg | mg | rate/% | rate/% | % |
| Chlorogenic | 7.03 | 1.0482 | 1.0523 | 2.0978 | 99.74 | 98.86 | 2.45 |
| acid | 7.04 | 1.0899 | 1.0523 | 2.1281 | 98.66 | | |
| | 6.98 | 1.1024 | 1.0523 | 2.1324 | 97.88 | | |
| | 7.05 | 1.0633 | 0.8419 | 1.9245 | 102.29 | | |
| | 7.01 | 1.0570 | 0.8419 | 1.9223 | 102.78 | | |
| | 7.02 | 1.0485 | 0.8419 | 1.8501 | 95.21 | | |
| | 7.04 | 1.0749 | 1.2628 | 2.3332 | 99.64 | | |
| | 7.04 | 1.1019 | 1.2628 | 2.3338 | 97.55 | | |
| | 7.13 | 1.0861 | 1.2628 | 2.2981 | 95.98 | | |

TABLE 4
Results of spike recovery test for ferulic acid
in test sample of Xiangdu Huoxue Plaster

| | | | | | | Average | |
|---|---|---|---|---|---|---|---|
| | Sampled | Sample | Added | Measured | Spike | spike | |
| | amount/ | content/ | amount/ | amount/ | recovery | recovery | RSD/ |
| Component | g | mg | mg | mg | rate/% | rate/% | % |
| Ferulic | 7.03 | 0.2643 | 0.2738 | 0.5341 | 98.51 | 98.20 | 1.34 |
| acid | 7.04 | 0.2684 | 0.2738 | 0.5329 | 96.61 | | |
| | 6.98 | 0.2726 | 0.2738 | 0.5421 | 98.43 | | |
| | 7.05 | 0.2642 | 0.2190 | 0.4761 | 96.77 | | |
| | 7.01 | 0.2592 | 0.2190 | 0.4786 | 100.15 | | |
| | 7.02 | 0.2596 | 0.2190 | 0.4729 | 97.39 | | |
| | 7.04 | 0.2604 | 0.3290 | 0.5820 | 97.75 | | |
| | 7.04 | 0.2677 | 0.3290 | 0.5987 | 100.63 | | |
| | 7.13 | 0.2785 | 0.3290 | 0.5995 | 97.58 | | |

TABLE 5
Results of spike recovery test for dracohodin
in test sample of Xiangdu Huoxue Plaster

| | | | | | | Average | |
|---|---|---|---|---|---|---|---|
| | Sampled | Sample | Added | Measured | Spike | spike | |
| | amount/ | content/ | amount/ | amount/ | recovery | recovery | RSD/ |
| Component | g | mg | mg | mg | rate/% | rate/% | % |
| Dracohodin | 7.03 | 0.7136 | 0.7169 | 1.4049 | 96.44 | 99.35 | 3.02 |
| | 7.04 | 0.7324 | 0.7169 | 1.4243 | 96.52 | | |
| | 6.98 | 0.7262 | 0.7169 | 1.4208 | 96.90 | | |
| | 7.05 | 0.7334 | 0.5696 | 1.3292 | 104.58 | | |
| | 7.01 | 0.7293 | 0.5696 | 1.3151 | 102.84 | | |
| | 7.02 | 0.7303 | 0.5696 | 1.3133 | 102.35 | | |
| | 7.04 | 0.7060 | 0.8591 | 1.5635 | 99.81 | | |
| | 7.04 | 0.7126 | 0.8591 | 1.5564 | 98.22 | | |
| | 7.13 | 0.7154 | 0.8591 | 1.5441 | 96.46 | | |

TABLE 6
Results of spike recovery test for cinnamaldehyde
in test sample of Xiangdu Huoxue Plaster

| | | | | | | Average | |
|---|---|---|---|---|---|---|---|
| | Sampled | Sample | Added | Measured | Spike | spike | |
| | amount/ | content/ | amount/ | amount/ | recovery | recovery | RSD/ |
| Component | g | mg | mg | mg | rate/% | rate/% | % |
| Cinnamaldehyde | 7.03 | 17.8837 | 18.2816 | 35.8821 | 98.45 | 99.49 | 2.46 |
| | 7.04 | 18.0294 | 18.2816 | 35.4964 | 95.54 | | |
| | 6.98 | 18.8092 | 18.2816 | 37.3939 | 101.66 | | |
| | 7.05 | 18.1419 | 14.6982 | 32.6664 | 98.82 | | |
| | 7.01 | 18.0341 | 14.6982 | 32.5803 | 98.97 | | |
| | 7.02 | 17.8899 | 14.6982 | 32.8832 | 102.01 | | |
| | 7.04 | 17.7743 | 22.2018 | 39.1971 | 96.49 | | |
| | 7.04 | 18.8010 | 22.2018 | 41.7912 | 103.55 | | |
| | 7.13 | 18.5303 | 22.2018 | 40.7076 | 99.89 | | |

TABLE 7
Results of spike recovery test for osthole in test sample of Xiangdu Huoxue Plaster

| | | | | | | Average | |
|---|---|---|---|---|---|---|---|
| | Sampled | Sample | Added | Measured | Spike | spike | |
| | amount/ | content/ | amount/ | amount/ | recovery | recovery | |
| Component | g | mg | mg | mg | rate/% | rate/% | RSD/% |
| Osthole | 7.03 | 2.4049 | 2.3793 | 4.8604 | 103.20 | 101.69 | 2.36 |
| | 7.04 | 2.5006 | 2.3793 | 4.9251 | 101.90 | | |
| | 6.98 | 2.5293 | 2.3793 | 4.9185 | 100.41 | | |
| | 7.05 | 2.4396 | 1.9188 | 4.3008 | 97.00 | | |
| | 7.01 | 2.4251 | 1.9188 | 4.3145 | 98.47 | | |
| | 7.02 | 2.4057 | 1.9188 | 4.3905 | 103.44 | | |
| | 7.04 | 2.4663 | 2.8876 | 5.4510 | 103.36 | | |
| | 7.04 | 2.5282 | 2.8876 | 5.5480 | 104.58 | | |
| | 7.13 | 2.4918 | 2.8876 | 5.4610 | 102.82 | | |

TABLE 8
Results of spike recovery test for ligustilide
in test sample of Xiangdu Huoxue Plaster

| | | | | | | Average | |
|---|---|---|---|---|---|---|---|
| | Sampled | Sample | Added | Measured | Spike | spike | |
| | amount/ | content/ | amount/ | amount/ | recovery | recovery | RSD/ |
| Component | g | mg | mg | mg | rate/% | rate/% | % |
| Ligustilide | 7.03 | 4.833 | 5.275 | 10.083 | 99.53 | 98.20 | 2.28 |
| | 7.04 | 5.025 | 5.275 | 10.093 | 96.07 | | |
| | 6.98 | 5.083 | 5.275 | 10.134 | 95.76 | | |
| | 7.05 | 4.903 | 4.22 | 9.127 | 100.11 | | |
| | 7.01 | 4.873 | 4.22 | 9.158 | 101.53 | | |
| | 7.02 | 4.834 | 4.22 | 9.096 | 100.97 | | |
| | 7.04 | 4.956 | 6.33 | 11.162 | 98.03 | | |
| | 7.04 | 5.081 | 6.33 | 11.136 | 95.66 | | |
| | 7.13 | 5.007 | 6.33 | 11.095 | 96.17 | | |

As shown in Tables 3 to 8, the QAMS approach provided in the present disclosure demonstrated high accuracy.

### 7. Determination of Relative Correction Factors

Cinnamaldehyde was selected as the internal standard because it is stable, exhibits a desirable peak shape, has a relatively high content, and is inexpensive and readily available. Mixed reference standard solutions with different mass concentrations were precisely drawn and determined under the same chromatographic conditions, and the peak areas of each chromatographic peak were recorded. The results are shown in Table 9.

TABLE 9
Correction factors for chlorogenic acid, ferulic
acid, dracohodin, ligustilide, and osthole

| Mixed reference standard | Chlorogenic | Ferulic | | | |
|---|---|---|---|---|---|
| solution | acid | acid | Dracohodin | Osthole | Ligustilide |
| Mixed reference standard A | 0.1104 | 0.0584 | 1.0384 | 0.0875 | 0.1459 |
| Mixed reference standard B | 0.1097 | 0.0594 | 1.0259 | 0.0844 | 0.1457 |
| Mixed reference standard C | 0.1125 | 0.0562 | 1.0161 | 0.0851 | 0.1416 |
| Mixed reference standard D | 0.1134 | 0.0569 | 1.0422 | 0.0820 | 0.1449 |
| Mixed reference standard E | 0.1087 | 0.0569 | 1.0294 | 0.0834 | 0.1457 |
| Mixed reference standard F | 0.1176 | 0.0577 | 1.0264 | 0.0841 | 0.1459 |
| Mean | 0.1121 | 0.0576 | 1.0297 | 0.0844 | 0.1449 |
| RSD % | 2.63 | 1.86 | 0.83 | 1.99 | 1.1672 |

From Table 9, the correction factor for chlorogenic acid was determined to be 0.1121, for ferulic acid 0.0576, for dracohodin 1.0297, for ligustilide 0.1449, and for osthole 0.0844.

### 8. Evaluation of Correction Factor Durability

### 8.1 Influence of Different HPLC Instruments and Different Chromatographic Columns on Correction Factors

Mixed Standard B was precisely drawn and determined using the HPLC conditions provided in the present disclosure, with the only difference being the use of different HPLC instruments (Shimadzu HPLC and Agilent 1200 HPLC) and different chromatographic columns (Agilent Eclipse XDB-C₁₈ column, Diamonsil C₁₈ column, and Welchrom C₁₈ column). The influence of different HPLC instruments and different chromatographic columns on the correction factors is shown in Table 10.

TABLE 10
Influence of different HPLC instruments and different
chromatographic columns on correction factors

| Apparatus | Chromatographic column | f_{chlorogenic acid} | f_{ferulic acid} | f_{dracohodin} | fₒₛₜₕₒₗₑ | f_{ligustilide} |
|---|---|---|---|---|---|---|
| Shimadzu | Agilent Eclipse XDB-C₁₈ | 0.1019 | 0.0596 | 1.1543 | 0.0900 | 0.1464 |
| | Diamonsil C₁₈ | 0.0942 | 0.0604 | 1.0958 | 0.0897 | 0.146 |
| | Welchrom C₁₈ | 0.0934 | 0.0588 | 1.1208 | 0.0888 | 0.1395 |
| Agilent | Agilent Eclipse XDB-C₁₈ | 0.1016 | 0.0599 | 1.1530 | 0.0906 | 0.147 |
| 1200 | Diamonsil C₁₈ | 0.0982 | 0.0584 | 1.0384 | 0.0875 | 0.1429 |
| | Welchrom C₁₈ | 0.0950 | 0.0581 | 1.0393 | 0.0898 | 0.1412 |

| | | | | | |
|---|---|---|---|---|---|
| Mean | 0.0974 | 0.0592 | 1.1003 | 0.0894 | 0.1438 |
| RSD % | 3.84 | 1.53 | 4.76 | 1.25 | 2.15 |

As shown in Table 10, the correction factors provided in the present disclosure demonstrated excellent durability when using different instruments and different chromatographic columns.

### 8.2 Influence of Different Injection Volumes, Different Flow Rates, and Different Column Temperatures on Correction Factors

Mixed Standard C was precisely drawn and determined using the HPLC conditions of the present disclosure, with the only differences being the use of different injection volumes (4, 6, 8, 10, and 12 μL), different flow rates (0.8, 0.9, 1, 1.1, and 1.2 mL/min), and different column temperatures (25, 28, 30, 32, and 35° C.). The influences of different injection volumes, different flow rates, and different column temperatures are shown in Tables 11 to 13, respectively.

TABLE 11
Influence of different injection volumes on correction factors

| Different | | | | | |
|---|---|---|---|---|---|
| injection | | | | | |
| volumes/μL | f_{chlorogenic acid} | f_{ferulic acid} | f_{dracohodin} | fₒₛₜₕₒₗₑ | f_{ligustilide} |
| 4 | 0.1095 | 0.0649 | 1.1444 | 0.0906 | 0.1478 |
| 6 | 0.1040 | 0.0630 | 1.1340 | 0.0906 | 0.1473 |
| 8 | 0.1085 | 0.0621 | 1.1219 | 0.0904 | 0.147 |
| 10 | 0.1175 | 0.0584 | 1.0384 | 0.0875 | 0.1429 |
| 12 | 0.1137 | 0.0618 | 1.1363 | 0.0907 | 0.1474 |
| Mean | 0.1107 | 0.0620 | 1.1150 | 0.0899 | 0.1465 |
| RSD % | 4.68 | 3.82 | 3.90 | 1.54 | 1.38 |

TABLE 12
Influence of different flow rates on correction factors

| Different | | | | | |
|---|---|---|---|---|---|
| flow rates/ | | | | | |
| mL · min⁻¹ | f_{chlorogenic acid} | f_{ferulic acid} | f_{dracohodin} | fₒₛₜₕₒₗₑ | f_{ligustilide} |
| 0.8 | 0.1282 | 0.0594 | 1.1314 | 0.0898 | 0.1427 |
| 0.9 | 0.1272 | 0.059 | 1.1137 | 0.0891 | 0.1450 |
| 1 | 0.1175 | 0.0584 | 1.0384 | 0.0875 | 0.1429 |
| 1.1 | 0.1282 | 0.06 | 1.1261 | 0.0905 | 0.1472 |
| 1.2 | 0.1317 | 0.0612 | 1.1573 | 0.0923 | 0.1500 |
| Mean | 0.1266 | 0.0596 | 1.1134 | 0.0898 | 0.1436 |
| RSD % | 0.12 | 0.05 | 1.13 | 0.08 | 2.12 |

TABLE 13
Influence of different column temperatures on correction factors

| Different | | | | | |
|---|---|---|---|---|---|
| column | | | | | |
| temperatures/ | | | | | |
| ° C. | f_{chlorogenic acid} | f_{ferulic acid} | f_{dracohodin} | fₒₛₜₕₒₗₑ | f_{ligustilide} |
| 25 | 0.1088 | 0.0586 | 1.0181 | 0.0879 | 0.1433 |
| 28 | 0.1150 | 0.0586 | 1.0280 | 0.0882 | 0.1439 |
| 30 | 0.1175 | 0.0584 | 1.0384 | 0.0875 | 0.1429 |
| 32 | 0.1198 | 0.0590 | 1.0666 | 0.0891 | 0.145 |
| 35 | 0.1233 | 0.0584 | 1.0832 | 0.0884 | 0.1437 |
| Mean | 0.1169 | 0.0586 | 1.0468 | 0.0882 | 0.1438 |
| RSD % | 4.65 | 0.40 | 2.60 | 0.69 | 0.55 |

As shown in Tables 11 to 13, the correction factors demonstrated excellent durability under different injection volumes, different flow rates, and different column temperatures.

### 9. Chromatographic Peak Localization of Target Components

The chromatographic peaks of the target components were localized using relative retention times (RRTs), i.e., the ratio of the retention time of each target component to the retention time of cinnamaldehyde. The reproducibility of the relative retention values across different HPLC instruments and different models of chromatographic columns, as well as under different injection volumes, different flow rates, and different column temperatures, was investigated. The results are shown in Tables 14 to 17.

TABLE 14
Influence of different HPLC instruments on t (RRT)

| Apparatus | Chromatographic column | t_{chlorogenic acid} | t_{ferulic acid} | t_{dracohodin} | tₒₛₜₕₒₗₑ | t_{ligustilide} |
|---|---|---|---|---|---|---|
| Shimadzu | Agilent Eclipse XDB-C₁₈ | 0.214 | 0.399 | 0.643 | 1.849 | 1.782 |
| | Diamonsil C₁₈ | 0.232 | 0.389 | 0.657 | 1.728 | 1.666 |
| | Welchrom C18 | 0.233 | 0.429 | 0.640 | 1.803 | 1.738 |
| Agilent | Agilent Eclipse XDB-C₁₈ | 0.214 | 0.398 | 0.644 | 1.854 | 1.824 |
| 1200 | Diamonsil C₁₈ | 0.218 | 0.406 | 0.686 | 1.897 | 1.829 |
| | Welchrom C₁₈ | 0.236 | 0.431 | 0.623 | 1.790 | 1.726 |

| | | | | | |
|---|---|---|---|---|---|
| Mean | 0.225 | 0.409 | 0.649 | 1.820 | 1.761 |
| RSD % | 4.58 | 4.18 | 3.28 | 3.25 | 3.58 |

TABLE 15
Influence of different injection volumes on RRT

| Different | | | | | |
|---|---|---|---|---|---|
| injection | | | | | |
| volumes/μL | t_{chlorogenic acid} | t_{ferulic acid} | t_{dracohodin} | tₒₛₜₕₒₗₑ | t_{ligustilide} |
| 4 | 0.219 | 0.408 | 0.681 | 1.892 | 1.824 |
| 6 | 0.218 | 0.407 | 0.679 | 1.896 | 1.828 |
| 8 | 0.218 | 0.408 | 0.678 | 1.893 | 1.825 |
| 10 | 0.218 | 0.406 | 0.686 | 1.897 | 1.810 |
| 12 | 0.218 | 0.407 | 0.676 | 1.893 | 1.825 |
| Mean | 0.218 | 0.407 | 0.680 | 1.894 | 1.822 |
| RSD % | 0.14 | 0.21 | 0.53 | 0.10 | 0.39 |

TABLE 16
Influence of different flow rates on RRT

| Different | | | | | |
|---|---|---|---|---|---|
| flow rates/ | | | | | |
| mL · min⁻¹ | t_{chlorogenic acid} | t_{ferulic acid} | t_{dracohodin} | tₒₛₜₕₒₗₑ | t_{ligustilide} |
| 0.80 | 0.228 | 0.412 | 0.682 | 1.829 | 1.763 |
| 0.90 | 0.223 | 0.409 | 0.689 | 1.874 | 1.807 |
| 1.00 | 0.218 | 0.406 | 0.686 | 1.897 | 1.848 |
| 1.10 | 0.213 | 0.375 | 0.696 | 1.966 | 1.895 |
| 1.20 | 0.208 | 0.400 | 0.700 | 2.015 | 1.902 |
| Mean | 0.218 | 0.401 | 0.690 | 1.916 | 1.843 |
| RSD % | 3.65 | 3.74 | 1.04 | 3.88 | 3.20 |

TABLE 17
Influence of different column temperatures on RRT

| Different | | | | | |
|---|---|---|---|---|---|
| column | | | | | |
| temperatures/ | | | | | |
| ° C. | t_{chlorogenic acid} | t_{ferulic acid} | t_{dracohodin} | tₒₛₜₕₒₗₑ | t_{ligustilide} |
| 25.00 | 0.215 | 0.405 | 0.677 | 1.869 | 1.802 |
| 28.00 | 0.216 | 0.405 | 0.686 | 1.927 | 1.858 |
| 30.00 | 0.218 | 0.406 | 0.686 | 1.897 | 1.791 |
| 32.00 | 0.216 | 0.405 | 0.692 | 1.951 | 1.881 |
| 35.00 | 0.219 | 0.407 | 0.690 | 1.916 | 1.847 |
| Mean | 0.217 | 0.406 | 0.686 | 1.912 | 1.836 |
| RSD % | 0.80 | 0.21 | 0.83 | 1.61 | 2.08 |

As shown in Tables 14 to 17, the RRTs demonstrated excellent reproducibility across different HPLC instruments, different models of chromatographic columns, different injection volumes, different flow rates, and different column temperatures.

Although the present disclosure is described in detail in conjunction with the foregoing examples, they are only a part of, not all of, the examples of the present disclosure. Other examples can be obtained based on these examples without creative efforts, and all of these examples shall fall within the protection scope of the present disclosure.

What is claimed is:

1. A method for simultaneous determination of chlorogenic acid, ferulic acid, dracohodin, cinnamaldehyde, ligustilide, and osthole in Xiangdu Huoxue Plaster, the method comprising:
dissolving a first cinnamaldehyde reference standard in methanol to obtain a cinnamaldehyde reference standard solution;
subjecting the cinnamaldehyde reference standard solution to first high-performance liquid chromatography (HPLC) detection, thereby obtaining a first cinnamaldehyde reference standard peak area;
removing a protective film from a test sample of the Xiangdu Huoxue Plaster, crushing the test sample, and subjecting an obtained crushed test sample to extraction with a first phosphoric acid-methanol solution to obtain a test sample solution; wherein the first phosphoric acid-methanol solution comprises phosphoric acid at a mass percentage of 2% to 4%;
subjecting the test sample solution to second HPLC detection, thereby obtaining a test sample peak area, and calculating a concentration of the cinnamaldehyde in the test sample solution by an external standard method based on a concentration of the cinnamaldehyde reference standard solution, the first cinnamaldehyde reference standard peak area, and the test sample peak area; and
calculating concentrations of the chlorogenic acid, the ferulic acid, the dracohodin, the ligustilide, and the osthole in the test sample solution based on the first cinnamaldehyde reference standard peak area, the test sample peak area, the concentration of the cinnamaldehyde in the test sample solution, and relative correction factors; wherein the relative correction factors comprise a chlorogenic acid correction factor, a ferulic acid correction factor, a dracohodin correction factor, an osthole correction factor, and a ligustilide correction factor;
the first HPLC detection and the second HPLC detection independently comprise following conditions: a chromatographic column is a C₁₈ chromatographic column; a mobile phase system comprises a mobile phase A and a mobile phase B, wherein the mobile phase A is an aqueous phosphoric acid solution, the mobile phase B is acetonitrile, and the aqueous phosphoric acid solution comprises phosphoric acid at a mass percentage of 0.1% to 0.4%; an elution mode is gradient elution, wherein a program of the gradient elution comprises: 0 min, a volume fraction of the mobile phase A is 95%; 0 min to 5 min, the volume fraction of the mobile phase A is decreased from 95% to 90%; 5 min to 15 min, the volume fraction of the mobile phase A is 90%; 15 min to 17 min, the volume fraction of the mobile phase A is decreased from 90% to 82%; 17 min to 30 min, the volume fraction of the mobile phase A is 82%; 30 min to 31 min, the volume fraction of the mobile phase A is decreased from 82% to 75%; 31 min to 41 min, the volume fraction of the mobile phase A is decreased from 75% to 70%; 41 min to 45 min, the volume fraction of the mobile phase A is 70%; 45 min to 50 min, the volume fraction of the mobile phase A is decreased from 70% to 65%; 50 min to 55 min, the volume fraction of the mobile phase A is decreased from 65% to 52%; 55 min to 85 min, the volume fraction of the mobile phase A is 52%; 85 min to 86 min, the volume fraction of the mobile phase A is decreased from 52% to 0%; 86 min to 90 min, the volume fraction of the mobile phase A is 0%; 90 min to 91 min, the volume fraction of the mobile phase A is increased from 0% to 95%; 91 min to 95 min, the volume fraction of the mobile phase A is 95%; and
the Xiangdu Huoxue Plaster comprises a backing material, a protective film, a Chinese herbal composition, and a matrix; wherein the matrix comprises following components in parts by mass: 10 parts to 45 parts of a framework material, 1 part to 3 parts of a cross-linking agent, 30 parts to 70 parts of a humectant, 1 part to 3 parts of a pH adjuster, 15 parts to 35 parts of a tackifier, and 50 parts to 120 parts of purified water; the Chinese herbal composition comprises following components in parts by mass: 5 parts to 24 parts of Radix Angelicae Pubescentis, 5 parts to 24 parts of Rhizoma Chuanxiong, 5 parts to 24 parts of Radix Vladimiriae, 4 parts to 14 parts of Fructus Foeniculi, 4 parts to 14 parts of Cortex Cinnamomi, 4 parts to 14 parts of Frankincense, 4 parts to 14 parts of Myrrh, 1 part to 12 parts of Radix Aconiti Preparata, 1 part to 12 parts of Radix Aconiti Kusnezoffii Preparata, 1 part to 12 parts of Resina Draconis, and 1 part to 8 parts of Borneol.

2. The method according to claim 1, wherein a process for obtaining the relative correction factors comprises:
dissolving a chlorogenic acid reference standard, a ferulic acid reference standard, a dracohodin reference standard, an osthole reference standard, a ligustilide reference standard, and a second cinnamaldehyde reference standard in a second phosphoric acid-methanol solution to obtain a mixed reference standard solution;
subjecting the mixed reference standard solution to third HPLC detection, thereby obtaining a mixed reference standard peak area; and
using the cinnamaldehyde as an internal standard, and calculating the relative correction factors by the internal standard method based on the mixed reference standard peak area and a concentration of the mixed reference standard solution; wherein
the mixed reference standard peak area comprises a chlorogenic acid reference standard peak area, a ferulic acid reference standard peak area, a dracohodin reference standard peak area, an osthole reference standard peak area, a ligustilide reference standard peak area, and a second cinnamaldehyde reference standard peak area; and
the third HPLC detection comprises following conditions: a chromatographic column is a C₁₈ chromatographic column; a mobile phase system comprises a mobile phase A and a mobile phase B, wherein the mobile phase A is an aqueous phosphoric acid solution, the mobile phase B is acetonitrile, and the aqueous phosphoric acid solution comprises phosphoric acid at a mass percentage of 0.1% to 0.4%; an elution mode is gradient elution, wherein a program of the gradient elution comprises: 0 min, a volume fraction of the mobile phase A is 95%; 0 min to 5 min, the volume fraction of the mobile phase A is decreased from 95% to 90%; 5 min to 15 min, the volume fraction of the mobile phase A is 90%; 15 min to 17 min, the volume fraction of the mobile phase A is decreased from 90% to 82%; 17 min to 30 min, the volume fraction of the mobile phase A is 82%; 30 min to 31 min, the volume fraction of the mobile phase A is decreased from 82% to 75%; 31 min to 41 min, the volume fraction of the mobile phase A is decreased from 75% to 70%; 41 min to 45 min, the volume fraction of the mobile phase A is 70%; 45 min to 50 min, the volume fraction of the mobile phase A is decreased from 70% to 65%; 50 min to 55 min, the volume fraction of the mobile phase A is decreased from 65% to 52%; 55 min to 85 min, the volume fraction of the mobile phase A is 52%; 85 min to 86 min, the volume fraction of the mobile phase A is decreased from 52% to 0%; 86 min to 90 min, the volume fraction of the mobile phase A is 0%; 90 min to 91 min, the volume fraction of the mobile phase A is increased from 0% to 95%; 91 min to 95 min, the volume fraction of the mobile phase A is 95%.

3. The method according to claim 2, wherein in the mixed reference standard solution, the second cinnamaldehyde reference standard is at a concentration of 80 μg/mL to 1,890 μg/mL; the chlorogenic acid reference standard is at a concentration of 38 μg/mL to 349 μg/mL; the ferulic acid reference standard is at a concentration of 81 μg/mL to 734 μg/mL; the dracohodin reference standard is at a concentration of 36 μg/mL to 324 μg/mL; the ligustilide reference standard is at a concentration of 90 μg/mL to 1,524 μg/mL; and the osthole reference standard is at a concentration of 28 μg/mL to 252 μg/mL.

4. The method according to claim 2, wherein the third HPLC detection further comprises following conditions: a column temperature is 25° C. to 35° C.; a flow rate of the mobile phase is 0.8 mL/min to 1.2 mL/min; an injection volume is 4 μL to 12 μL; and a detection wavelength is 319 nm to 324 nm.

5. The method according to claim 2, wherein each of the relative correction factors is calculated by a formula: f_{i/r}=AᵢCᵣ/AᵣCᵢ;
f_{i/r} is the relative correction factor; Aᵢ is the second cinnamaldehyde reference standard peak area; Cᵢ is the concentration of the second cinnamaldehyde reference standard in the mixed reference standard solution; Aᵣ is a peak area of a reference standard to be corrected; and Cᵣ is a concentration of the reference standard to be corrected in the mixed reference standard solution; and
the reference standard to be corrected comprises the chlorogenic acid reference standard, the ferulic acid reference standard, the dracohodin reference standard, the osthole reference standard, and the ligustilide reference standard.

6. The method according to claim 1, wherein the first cinnamaldehyde reference standard in the cinnamaldehyde reference standard solution is at a concentration of 80 μg/mL to 1,890 μg/mL.

7. The method according to claim 1, wherein the first HPLC detection and the second HPLC detection independently further comprise following conditions: a column temperature is 25° C. to 35° C.; a flow rate of the mobile phase is 0.8 mL/min to 1.2 mL/min; an injection volume is 4 μL to 12 μL; and a detection wavelength is 319 nm to 324 nm.

8. The method according to claim 1, wherein the test sample of the Xiangdu Huoxue Plaster and the first phosphoric acid-methanol solution are at a solid-to-liquid ratio of 1 g:(3.56-5) mL.

9. The method according to claim 1, wherein the extraction comprises ultrasonic extraction; and the extraction is conducted at 20° C. to 60° C. for 20 min to 40 min.

10. The method according to claim 1, wherein the concentrations of the chlorogenic acid, the ferulic acid, the dracohodin, the ligustilide, and the osthole in the test sample solution are calculated by a formula: Cₓ=AₓCᵢᵢf_{i/r}/Aᵢᵢ;
Cₓ is the concentration of the chlorogenic acid, the ferulic acid, the dracohodin, the osthole, or the ligustilide in the test sample solution; Aₓ is the test sample peak area for the chlorogenic acid, the ferulic acid, the dracoside, the osthole, or the ligustilide; Cᵢᵢ is the concentration of the first cinnamaldehyde reference standard in the cinnamaldehyde reference standard solution; Aᵢᵢ is the first cinnamaldehyde reference standard peak area; and f_{i/r} is the relative correction factor.

11. The method according to claim 3, wherein the third HPLC detection further comprises following conditions: a column temperature is 25° C. to 35° C.; a flow rate of the mobile phase is 0.8 mL/min to 1.2 mL/min; an injection volume is 4 μL to 12 μL; and a detection wavelength is 319 nm to 324 nm.

12. The method according to claim 6, wherein the first HPLC detection and the second HPLC detection independently further comprise following conditions: a column temperature is 25° C. to 35° C.; a flow rate of the mobile phase is 0.8 mL/min to 1.2 mL/min; an injection volume is 4 μL to 12 μL; and a detection wavelength is 319 nm to 324 nm.

13. The method according to claim 8, wherein the extraction comprises ultrasonic extraction; and the extraction is conducted at 20° C. to 60° C. for 20 min to 40 min.

14. The method according to claim 8, wherein the concentrations of the chlorogenic acid, the ferulic acid, the dracohodin, the ligustilide, and the osthole in the test sample solution are calculated by a formula: Cₓ=AₓCᵢᵢf_{i/r}/Aᵢᵢ;
Cₓ is the concentration of the chlorogenic acid, the ferulic acid, the dracohodin, the osthole, or the ligustilide in the test sample solution; Aₓ is the test sample peak area for the chlorogenic acid, the ferulic acid, the dracoside, the osthole, or the ligustilide; Cᵢᵢ is the concentration of the first cinnamaldehyde reference standard in the cinnamaldehyde reference standard solution; Aᵢᵢ is the first cinnamaldehyde reference standard peak area; and f_{i/r} is the relative correction factor.
